(19) United States
(12) Patent Application Publication
(10) Pub. No.: US 2015/0012404 A1
(43) Pub. Date: Jan. 8, 2015

(54) Displaying Market Data in Multiple Formats

(71) Applicant: Trading Technologies International, Inc., Chicago, IL (US)

(72) Inventor: Brian J. Buck, Livermore, CA (US)

(21) Appl. No.: 13/934,997

(22) Filed: Jul. 3, 2013

(51) Int. Cl. G06Q 40/04

(52) U.S. Cl. CPC G06Q 40/04
USPC 705/37

(57) ABSTRACT

Some embodiments of the invention provide systems and methods for displaying market data which are operatively configured to alternate the presentation of the market data between multiple formats responsive to a user selection, wherein at least one of the formats is condensed by converting numerical values to graphical or visual representations thereof which reduces the amount of cognitive workload required to review, detect, and monitor the market data, among other things, while also continuing to convey useful information that facilitates the execution of trades in tradable objects.

### CROSS-REFERENCE TO RELATED APPLICATIONS

This patent document relates to U.S. Pat. No. 6,772,132, entitled “Click Based Trading with Intuitive Grid Display of Market Depth,” issued on Aug. 3, 2004, the content of which is incorporated herein by reference.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

It should be understood that the trading device may be any computing device, such as a personal computer, laptop computer, hand-held computer, tablet computer, smart phone or some other device that includes a display, user interface and includes hardware for communication with the electronic exchange.

Traders often use automated or semi-automated trading tools, collectively hereinafter referred to as automated tools, that automatically or semi-automatically send orders for tradable objects to the exchange. Many different trading tools are usually provided to, among other things, facilitate fast and accurate order entry. For instance, an automated or semi-automated tool might quickly calculate one or more order parameters, such as order price or order quantity, based on market conditions, or some other reference condition, and then automatically send an order with these parameters to an exchange for matching.

Traders frequently execute trading strategies that require the constant tracking of a large amount of individual tradable objects and the need to assimilate large amounts of data in order to recognize market trends, view current market conditions, and quickly enter, cancel, update, and modify orders. Thus, traders employ specialized trading interfaces for assistance. Trading interfaces present a variety of information, which may include the status of each tradable object in a line of numeric data fields covering key variables relevant to trading, such as price, quantity available at each price, the level of inside market, and others. Traders may regularly operate many such trading interfaces in order to track market conditions for a plurality of tradable objects and execute various trading strategies simultaneously. The use of multiple interfaces can become burdensome to a trader who needs to accurately and fast view critical changes in the market conditions of a large number of tradable objects. For example, the interfaces require space on the trader's screen and require high levels of visual scanning which make it difficult to detect and analyze changes in market conditions on a real time basis as necessary to properly execute trading strategies. Additionally, when a trader uses a plurality of interfaces to execute trading strategies based on a large number of tradable objects, the presence of multiple interfaces can make it difficult and time consuming to monitor the status and relative positions of working orders and net positions for each tradable object. In short, the interfaces that are supposed to help the trader operate more efficiently and effectively can ultimately become overwhelming to the detriment of the trader.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an exemplary trading interface format for presenting market data relating to a tradable object which may be employed with certain disclosed embodiments.

FIG. 5 illustrates a first exemplary trading interface format for presenting market data relating to a tradable object in a condensed form relative to the exemplary trading interface format shown in FIG. 4 which may be employed with certain disclosed embodiments.

FIG. 6 illustrates a second exemplary trading interface format for presenting market data relating to a tradable object in a condensed form relative to the exemplary trading interface format shown in FIG. 4 which may be employed with certain disclosed embodiments.

FIG. 7 illustrates a third exemplary trading interface format for presenting market data relating to a tradable object in a condensed form relative to the exemplary trading interface format shown in FIG. 4 which may be employed with certain disclosed embodiments.

FIG. 8 illustrates a display device screen displaying multiple exemplary trading interfaces for presenting market data relating to a tradable object as shown in FIG. 4.

FIG. 9 illustrates a display device screen displaying multiple first exemplary trading interfaces as shown in FIG. 5 for presenting market data relating to a tradable object in a condensed form relative to the exemplary trading interface format shown in FIG. 8, which may be employed with certain disclosed embodiments.

FIG. 10 illustrates a display device screen displaying multiple exemplary trading interfaces as shown in FIG. 4 and multiple first exemplary trading interfaces for presenting market data relating to a tradable object in a condensed form relative to the exemplary trading interface format as shown in FIG. 5, all of which may be employed with certain disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosed embodiments generally relate to systems and methods for providing trading interfaces that include trading tools and display market data in a manner that assists traders in executing trades. Some embodiments are directed to systems and methods for displaying market data which are operatively configured to alternate the presentation of the market data between multiple formats responsive to a user selection, wherein at least one of the formats is condensed by converting numerical values to graphical or visual representations thereof which reduces the amount of cognitive workload required to review, detect, and monitor the market data, among other things, while also continuing to convey useful information that facilitates the execution of trades in tradable objects.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways. Furthermore, well known process steps and computer components may have not been described in detail herein in order to avoid unnecessarily obscuring the underlying concepts.

### I. Brief Description of Certain Embodiments

In one embodiment, a method for displaying market data which is facilitated by a computing device in communication with an electronic exchange is disclosed. The method comprises the steps of displaying a first interface format for presenting current market data in a first area of a display device and displaying a second interface format for presenting current market data in a second area of the display device responsive to receiving a user selection through a user input device.

In some embodiments, the first interface format includes a plurality of generally axially aligned price regions defining a central price axis, a plurality of ask regions and a plurality of bid regions. Each of the axially aligned price regions contains a current numerical price for a tradable object in sequential order along the price axis. Each ask region of the plurality of ask regions is transversely aligned to a price region relative to the central price axis and contains a numerical value representing a current ask quantity at the price displayed in the transversely aligned price region, thereby displaying a positional relationship between the current ask quantity and price along the central price axis. Each bid region of the plurality of bid regions is transversely aligned to a price region and contains a numerical value representing a current bid quantity at the price displayed in the transversely aligned price region, thereby displaying a positional relationship between the current bid quantity and price along the central price axis.

In some embodiments, the second interface format includes displaying a visual representation of the magnitude of the numerical value for the current bid quantity and a visual representation of the magnitude of the numerical value for the current ask quantity. In particular, each visual representation is displayed in a position corresponding to the positional relationship between the current bid quantity and price or the current ask quantity and the price as displayed in the first interface format.

Some embodiments of a system for displaying market data which includes a computing device in a communication with an electronic exchange are disclosed. The system comprises a display device for displaying a first interface format of current market data in a first area of the display device, wherein the first interface format may include all of the features described above and/or the features of the exemplary embodiments described herein below, and a user input device for receiving a user selection to display a second interface format of current market data in a second area of the display device, the second area being smaller than the first area, wherein the second interface format may include all of the features described above and/or the features of the exemplary embodiments described herein.

Other embodiments are directed to a non-transitory computer-readable information recording medium which stores a program for controlling a computer to receive market data from an electronic exchange, the program comprising code for permitting the computer to perform the steps for displaying the first interface format including all of the features described above and/or the features of the exemplary embodiments described herein below, and displaying a second interface format of current market data in a second area of the display device, the second area being smaller than the first area, responsive receiving a user selection to through a user input device, wherein the second interface format may include all of the features described above and/or the features of the exemplary embodiments described herein.

### II. Example Electronic Trading System

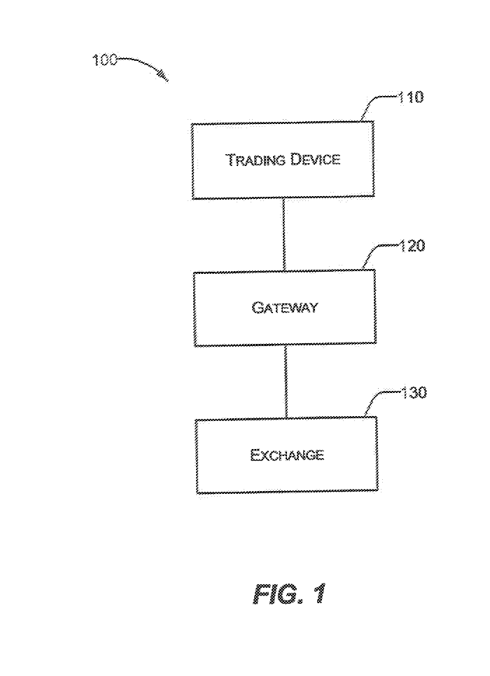

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

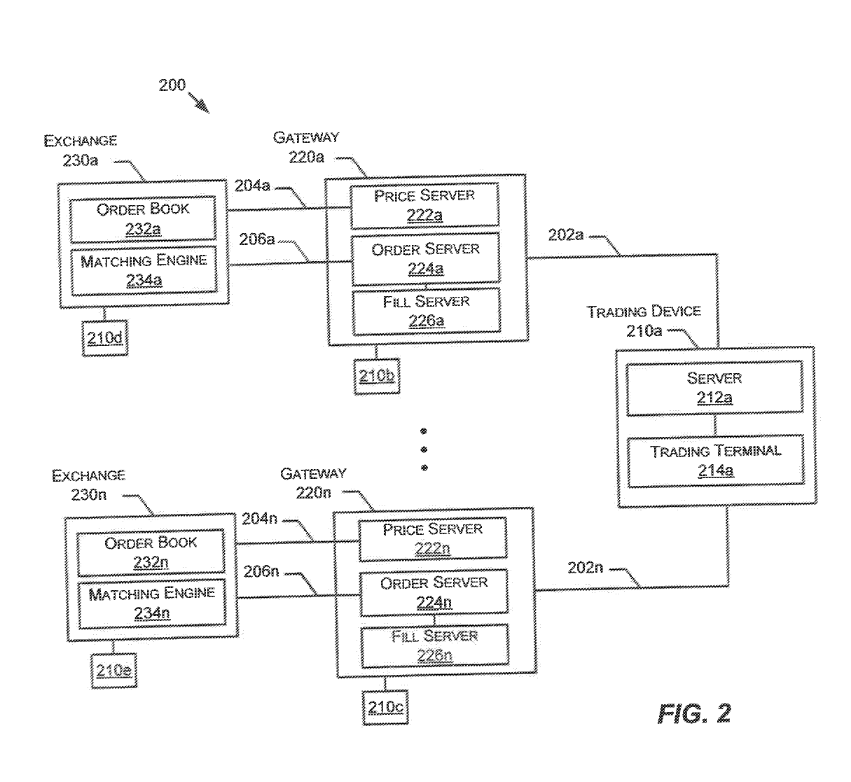

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 120 than the trading terminal 214a. As a result, the server 212a latency benefits that are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates or enables communication between, for example, the trading device 210a, the gateway 220a and the exchange 220a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradeable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book may include data relating to a market for a tradeable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. Example Computing Device

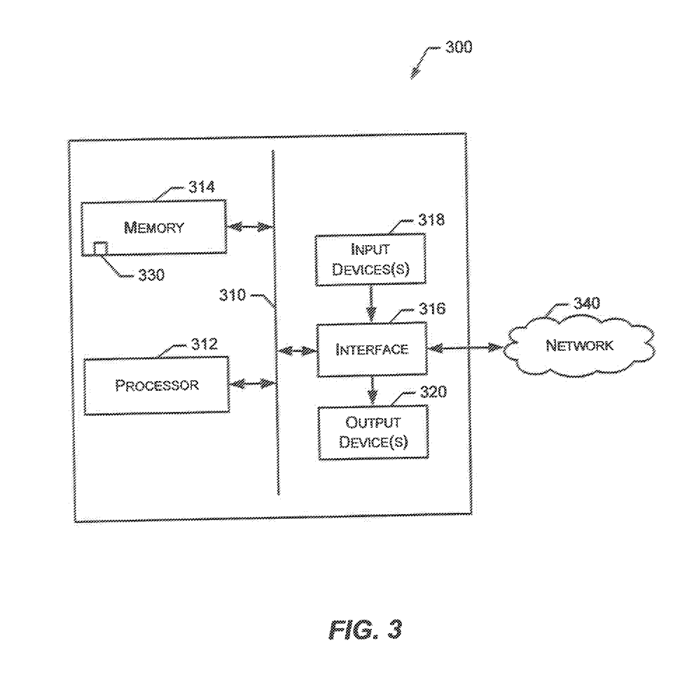

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Displaying Market Data in Multiple Formats

Exemplary embodiments described below include various trading interfaces that present market data in multiple formats which are intended to allow a trader to gain a fast, accurate, and comprehensive view of the current market conditions for a large number of tradable objects through data visualization, among other things. It should be understood that market data is not limited to any particular types of data, and may include information received directly from the exchange 130 or data generated by the trading device 300 (as a function of the market data received from the exchange 130 or otherwise), for example.

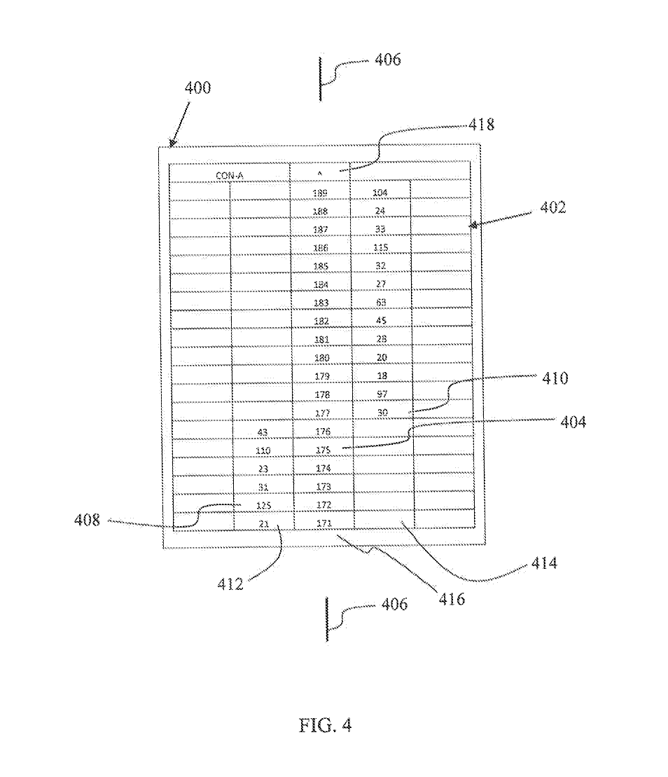

FIG. 4 provides an embodiment of an exemplary trading interface of the invention referred to herein as a trading interface format 402 for presenting market data relating to a tradable object. Interface format 402 may be displayed in a display area 400 defined on any type of display device in communication with computing device 300, and may be connected with or otherwise comprise output device 320.

In this embodiment, trading interface format 402 includes a plurality of price regions 404 arranged in axial alignment with one another defining a central axis 406. Interface format 402 further includes a plurality of bid quantity regions 408 and a plurality of ask quantity regions 410. The plurality of bid quantity regions 408 are axially aligned with one another defining a bid quantity column 412 having an axis which is parallel to central axis 406. The plurality of bid quantity regions 408 are located in a generally a transverse position with respect to central axis 406 defined by the plurality of price regions 404. The plurality of ask quantity regions 410 are axially aligned with one another defining an ask quantity column 414 having an axis which is parallel to central axis 406. The plurality of ask quantity regions 410 are therefore located in a generally a transverse position with respect to central axis 406 defined by the plurality of price regions 404, similarly to the plurality of bid quantity regions 408 but on the opposing side of central axis 406 in this embodiment.

Each price region 404 in interface format 402 contains a numerical value representing a price for the tradable object. Either the bid quantity region 408 or the ask quantity region 410 transversely adjacent to each price region 404 may contain a numerical value representing the bid quantity or ask quantity for the tradable object at the numerical price value shown in the price region 404. In this embodiment, the numerical price values shown in price regions 404 are presented in sequential order from lowest price at a bottom 416 of interface format 402 to highest price at a top 418 of interface format 402.

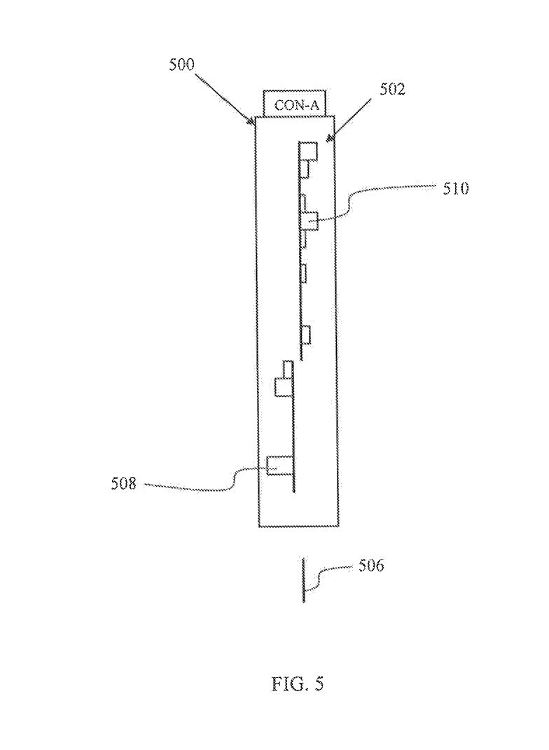

FIG. 5 provides a modified or condensed trading interface format 502 for presenting the same market data relating to a tradable object as presented in interface format 402. Interface format 502 may be displayed in a display area 500 defined on any type of display device in communication with computing device 300, and may be connected with or otherwise comprise output device 320. Display area 500 requires less area of the display device than display area 400, and may consist of a portion of display area 400. In some embodiments, display area 500 is smaller than display area 400 but may be of a different shape than display area 400 in order to better accommodate trading interface 502.

In this embodiment, trading interface format 502 includes a visual representation of the numerical values contained in the bid quantity regions 408 and ask quantity regions 410 in stead of the actual numerical values shown presented in interface format 402. In other words, the current bid quantity or ask quantity for any given price value is replaced by a representative display, which may be one or more graphics, symbols, colors or anything else that readily suggests, or allows a trader to visualize, the relative numerical value the representative display replaces.

In the embodiment shown in FIG. 5, a central axis 506 is displayed in interface format 502 without price regions 404. Bid quantity regions 408 have been replaced by rectangles or bars 508 which extend transversely with respect to central axis 506 as shown in interface format 502. Ask quantity regions 410 have also been replaced by rectangles or bars 510 which as shown in interface format 502 also extend transversely with respect to central axis 506 albeit in the opposite direction of bars 508.

Each bar 508 was formed for display in trading interface 502 by converting the numerical values contained in the corresponding bid quantity region 408 into representations of the magnitude of each numerical value with respect to the other numerical values in all bid quantity regions 408. In other words, bars 508 are scaled or normalized visual representations of the bid quantity magnitude associated with the transversely adjacent price for the trading object, which although not shown in this embodiment, is suggested from the positional location of each bar relative to an imaginary (that is, not displayed) central axis 506 as compared with trading interface format 402. Likewise, each bar 510 was formed for display in trading interface 502 by converting the numerical values contained in the corresponding ask quantity region 410 into representations of the magnitude of each numerical value with respect to the other numerical values in all ask quantity regions 410. Thus, all of the numerical values in bid regions 408 and ask regions 410 shown in trading interface 402 have been converted into visualizations for display in trading interface 502 that reveal a relative amount of bid quantities or ask quantities relative to a particular price.

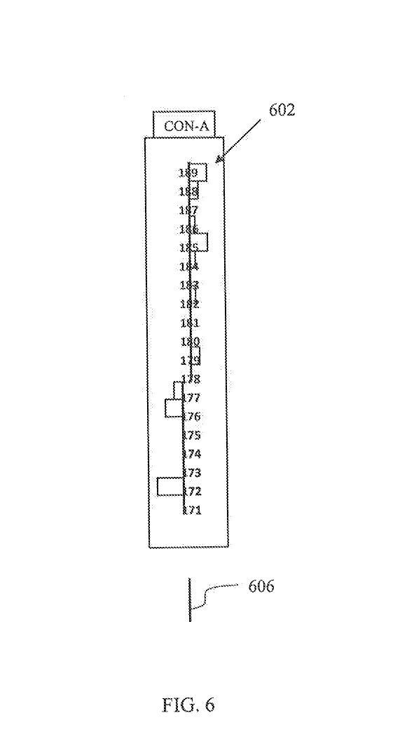

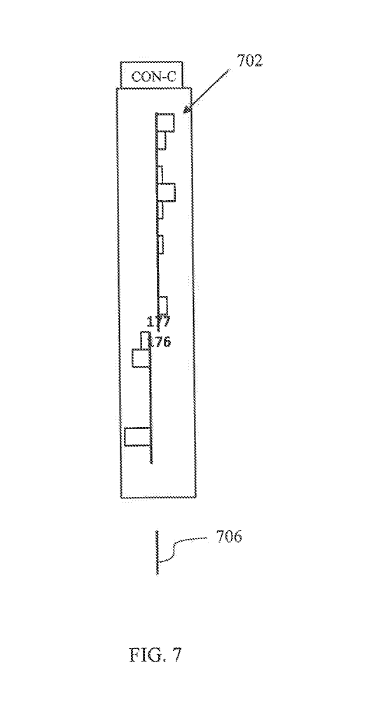

In other embodiments, shown in FIG. 6 and FIG. 7, some or all of the numerical prices shown in price regions 404 of trading interface 402 may be displayed in a modified or condensed trading interface. For example, in FIG. 6, a trading interface 602 includes numerical price values from price regions 404 being displayed as superimposed over imaginary central axis 606. In FIG. 7, a trading interface 702 includes only some of the numerical price values from price regions 404 being displayed as superimposed over an imaginary central axis 706. In trading interface 702 the numerical price values displayed correspond to the prices associated with the inside market, other prices may be displayed, such as the intermediate price levels if there is a wider spread in the inside market.

The data visualization and display of the modified or condensed trading interfaces on a display device, such as interfaces 502, 602 and 702, is responsive to receipt of a selection thereof by computing device 300 which may be received through input device 318 or any conventional method and system for indicating a preference in a computerized environment.

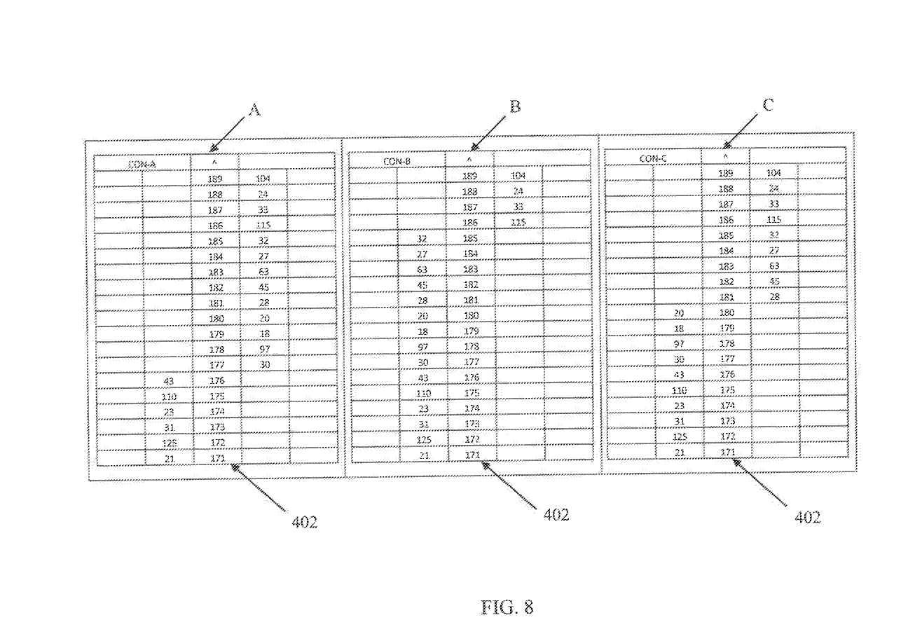

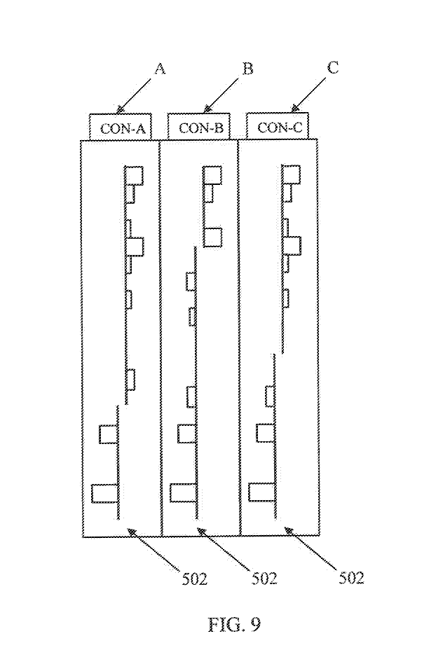

For example, trading interfaces of the invention, such as interfaces 402, 502, 602 and 702, may incorporate user-friendly features and fit seamlessly with other operating system interfaces, that is, in a framed form having borders, multiple folders, toolbars with pull-down menus, embedded links to other screens and various other selectable features associated with animated graphical representations of depressible buttons that may be can be selected (i.e., “clicked on” or “touched”) by the user via input device 318, which may include or comprise a connected mouse, keyboard or touch-enabled display device. Thus, a user may alternately toggle between trading interface 402, and for example, interface 502 and/or other interfaces 602 and 702, by clicking on tabs A, B or C as shown by FIG. 8 and FIG. 9. In some embodiments, one or more of the tabs A, B and C can linked such as a group of tabs corresponding to the legs in a spread. For example, the tab A may represent a spread and tabs B and C could represent individual legs associated with the spread. In this example, actions or modifications such as a re-centering command, or a minimize command could be applied to all of the linked or grouped tabs simply by applying the modification to one of the tabs. In this way, a series of linked or grouped tabs could be controlled via common commands allowing the user to organize their trading interfaces and desktop.

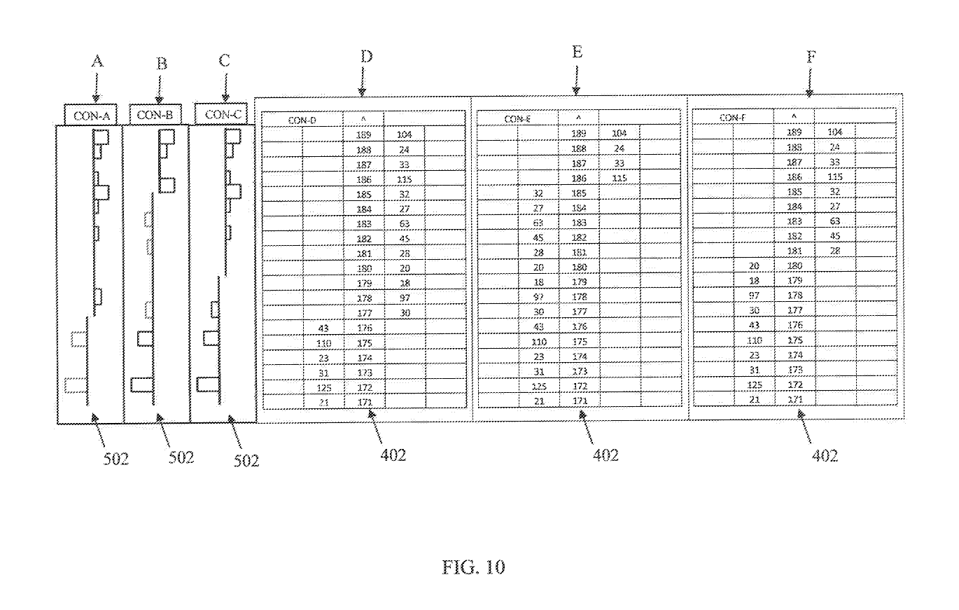

The embodiments herein describe new systems, methods and interfaces that allow a trader to better visualize the status of a large number of orders corresponding to a plurality of tradable objects shown on their display screen. As shown in the examples of FIG. 10, the market date for each tradable object A-F may include market data presented in alternative trading interfaces 402 (tabs D-F) or 502 (tabs A-C) as described herein. Trading interfaces 502, 602 and 702 may include all the same features, capabilities and tools of trading interface 402, such as the ability to execute a trade through a “click” of the mouse for example. Examples of click based trading features and functionality that may be incorporated into one or more of the trading interfaces 402, 502, 602 and 702 are disclosed and described in U.S. Pat. No. 6,772,132, entitled “Click Based Trading with Intuitive Grid Display of Market Depth,” the content of which is incorporated herein by reference.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method for displaying market data facilitated by a computing device in a communication with an electronic exchange, the method comprising the steps of:
a) displaying a first interface format for presenting current market data in a first area of a display device including:
i) a plurality of generally axially aligned price regions defining a central price axis, wherein each of the axially aligned price regions contain therein a current numerical price for a tradable object in sequential order along the price axis;
ii) a plurality of ask regions, wherein each ask region of the plurality of ask regions is transversely aligned to a price region relative to the central price axis and contains a numerical value representing a current ask quantity at the price displayed in the transversely aligned price region, thereby displaying a positional relationship between the current ask quantity and price along the central price axis;
iii) a plurality of bid regions, wherein each bid region of the plurality of bid regions is transversely aligned to a price region relative to the central price axis and contains a numerical value representing a current bid quantity at the price displayed in the transversely aligned price region, thereby displaying a positional relationship between the current bid quantity and price along the central price axis;
b) responsive to receiving a user selection through a user input device, displaying a second interface format for presenting current market data in a second area of the display device, the second area being smaller than the first area, wherein the second interface format includes:
i) a visual representation of the magnitude of the numerical value for the current bid quantity contained in each of the bid regions of the plurality of bid regions displayed in the first interface format, wherein each visual representation is displayed in a position corresponding to the positional relationship between the current bid quantity and price displayed in the first interface format; and
ii) a visual representation of the magnitude of the numerical value for the current ask quantity contained in each of the ask regions of the plurality of ask regions displayed in the first interface format, wherein each visual representation is displayed in a position corresponding to the positional relationship between the current ask quantity and price displayed in the first interface format.

2. The method according to claim 1, wherein the second area of the display device is shown in a portion of the first area of the display device.

3. The method according to claim 1, wherein the central price axis line is displayed vertically on the display.

4. The method according to claim 1, wherein the visual representations in the ask regions and the visual representations in the bid regions are displayed as transversely aligned to opposing sides in the second interface format.

5. The method according to claim 1, wherein the visual representations of the magnitude of the numerical value for the current bid quantity comprise a graphic of a size that is scaled relative to all of the current bid quantities in the plurality bid regions.

6. The method according to claim 1, wherein the visual representations of the magnitude of the numerical value for the current ask quantity comprise a graphic of a size that is scaled relative to all of the current ask quantities in the plurality ask regions.

7. The method according to claim 1, further comprising the step of displaying one or more of the current numerical prices in the second interface format.

8. The method according to claim 1, wherein one or more of the visual representations include one or more colors.

9. The method according to claim 1, further comprising the step of redisplaying the first interface format after displaying the second interface format responsive to receiving a user selection thereof through a user input device.

10. A system for displaying market data comprising:
a) a computing device in a communication with an electronic exchange;
b) a display device for displaying a first interface format of current market data in a first area of the display device, wherein the first interface format includes:
c) displaying a first interface format for presenting current market data in a first area of a display device including:
i) a plurality of generally axially aligned price regions defining a central price axis, wherein each of the axially aligned price regions contain therein a current numerical price for a tradable object in sequential order along the price axis;
ii) a plurality of ask regions, wherein each ask region of the plurality of ask regions is transversely aligned to a price region relative to the central price axis and contains a numerical value representing a current ask quantity at the price displayed in the transversely aligned price region, thereby displaying a positional relationship between the current ask quantity and price along the central price axis;
iii) a plurality of bid regions, wherein each bid region of the plurality of bid regions is transversely aligned to a price region relative to the central price axis and contains a numerical value representing a current bid quantity at the price displayed in the transversely aligned price region, thereby displaying a positional relationship between the current bid quantity and price along the central price axis;
d) a user input device for receiving a user selection to display a second interface format of current market data in a second area of the display device, the second area being smaller than the first area, wherein the second interface format includes:
i) a visual representation of the magnitude of the numerical value for the current bid quantity contained in each of the bid regions of the plurality of bid regions displayed in the first interface format, wherein each visual representation is displayed in a position corresponding to the positional relationship between the current bid quantity and price displayed in the first interface format; and
ii) a visual representation of the magnitude of the numerical value for the current ask quantity contained in each of the ask regions of the plurality of ask regions displayed in the first interface format, wherein each visual representation is displayed in a position corresponding to the positional relationship between the current ask quantity and price displayed in the first interface format.

11. The system of claim 10, wherein the display device and computing device are mounted in a unitary housing.

12. The system of claim 10, wherein the user display device and user input device are mounted in a unitary housing.

13. The system of claim 10, wherein the visual representations of the magnitude of the numerical value for the current bid quantity comprise a graphic of a size that is scaled relative to all of the current bid quantities in the plurality bid regions.

14. The system of claim 10, wherein the visual representations of the magnitude of the numerical value for the current ask quantity comprise a graphic of a size that is scaled relative to all of the current ask quantities in the plurality ask regions.

15. The system of claim 10, further comprising the step of displaying one or more of the current numerical prices in the second interface format.

16. The system of claim 10, wherein the first interface format is redisplayed responsive to receiving a user selection thereof through the user input device.

17. A non-transitory computer-readable information recording medium which stores a program for controlling a computer to receive market data from an electronic exchange, the program comprising code for permitting the computer to perform the following steps:
a) displaying a first interface format for presenting current market data in a first area of a display device including:
i) a plurality of generally axially aligned price regions defining a central price axis, wherein each of the axially aligned price regions contain therein a current numerical price for a tradable object in sequential order along the price axis;
ii) a plurality of ask regions, wherein each ask region of the plurality of ask regions is transversely aligned to a price region relative to the central price axis and contains a numerical value representing a current ask quantity at the price displayed in the transversely aligned price region, thereby displaying a positional relationship between the current ask quantity and price along the central price axis;
iii) a plurality of bid regions, wherein each bid region of the plurality of bid regions is transversely aligned to a price region relative to the central price axis and contains a numerical value representing a current bid quantity at the price displayed in the transversely aligned price region, thereby displaying a positional relationship between the current bid quantity and price along the central price axis;
b) responsive to receiving a user selection through a user input device, displaying a second interface format for presenting current market data in a second area of the display device, the second area being smaller than the first area, wherein the second interface format includes:
i) a visual representation of the magnitude of the numerical value for the current bid quantity contained in each of the bid regions of the plurality of bid regions displayed in the first interface format, wherein each visual representation is displayed in a position corresponding to the positional relationship between the current bid quantity and price displayed in the first interface format; and
ii) a visual representation of the magnitude of the numerical value for the current ask quantity contained in each of the ask regions of the plurality of ask regions displayed in the first interface format, wherein each visual representation is displayed in a position corresponding to the positional relationship between the current ask quantity and price displayed in the first interface format.
